(19) United States
(12) Patent Application Publication
(10) Pub. No.: US 2006/0089027 A1
(43) Pub. Date: Apr. 27, 2006

(54) Locking cable termination device with improved security

(75) Inventors: Shawn Chawgo, Liverpool, NY (US); Noah Montena, Syracuse, NY (US)

Correspondence Address: WALL MARJAMA & BILINSKI, 101 SOUTH SALINA STREET, SUITE 400, SYRACUSE, NY, 13202, US

(73) Assignee: John Mezzalingua Associates, Inc., East Syracuse, NY (US)

(21) Appl. No.: 10/971,230

(22) Filed: Oct. 22, 2004

(51) Int. Cl. H01R 13/44

(52) U.S. Cl. 439/133

(57) ABSTRACT

A tamper-resistant termination device for a cable port comprising a housing having a first end which includes an inner wall bounding a first central bore, the inner wall having a first recess; a connector body configured to fit within the housing having internal threads for mating with a cable port, the connector body having a second recess which can be rotationally aligned with the first recess; and a locking member disposed for movement from a first position located substantially within either the first recess or the second recess to a second position wherein the locking member is partially disposed within said first recess and partially disposed within said second recess. When the locking member is in the first position, the housing rotates independently of the connector body. When the locking member is in the second position, rotation of the housing affects a rotation of the connector body. The locking member is selectively moved between the first and second positions by either attractive or repulsive magnetic force applied by a complementary tool comprising a magnet. A method for terminating a cable port using the tamper-resistant termination device and complementary magnetic tool is also taught.

### FIELD OF THE INVENTION

This invention relates generally to devices used to terminate unused cable ports, terminals or the like. More particularly, the invention is useful for, although not limited to, terminating an unused coaxial cable outlet terminal of the type employed in the cable television industry.

### BACKGROUND OF THE INVENTION

Community antenna television (CATV) systems are conventionally organized so that a communication signal generated at a central antenna can be received by several individual subscribers who are connected to a single coaxial cable that carries the signal. The system functions by connecting devices, such as directional taps, along the cable, and servicing subscribers with a drop line that is connected to one of the devices. Such devices typically have a plurality of output ports so that service can efficiently be provided to many subscribers in the same geographical area. Each of the output ports is usually a female coaxial plug to which the drop line for an individual subscriber is connected.

In many instances, the number of output ports on one of the devices exceeds the actual number of subscribers that are serviced by that device. In such instances, it is desirable to terminate the unused output ports. Termination of the unused output ports serves two principal functions. First, by terminating such output ports with termination devices that have impedances selected to match the impedance of the coaxial cable, there is no impedance mismatch between the signal-carrying cable and the active subscriber cables that are connected. Second, the presence of termination devices on the unused output ports acts to prevent theft of the cable signal by non-subscribers who could otherwise simply attach a coaxial cable themselves to any vacant output port. Alternatively, a termination device may be positioned between a previously used output port and the corresponding drop line when the service to that particular subscriber is suspended without requiring that the full wiring to that subscriber be removed. Service can be restored simply by removing the interposed termination device. The theft of cable services has become a growing concern of late as more sophisticated thieves have circumvented the available tamper resistant features of existing termination devices.

It is readily apparent that the security of these functions can only be achieved if the termination device is designed so that it is resistant to attempts by unauthorized individuals to remove it after it has been installed. As a result, in the prior art there have been developed termination devices that require the use of a special tool that is not available to the general public in order to remove the termination device. An example of such a termination device is described in U.S. Pat. No. 6,491,546 (Perry), the disclosure of which is incorporated by reference herein. In these patents, the termination device is of the type that includes a connector body that is rotatably encapsulated within a shield. This shield contains two ports: one port receives a cable terminal and the other port is used to provide access to a socket in the connector body. This socket is especially adapted to receive a specialized tool that can be used to rotate the connector body within the shield and thereby fasten or unfasten the termination device to an output port. In such prior art devices, however, the designs for the interaction between the termination devices and the specialized tools often make the tools difficult to use. Additionally, with other such prior art devices, more sophisticated cable-service thieves can visually identify and circumvent the structure of tamper-resistant features by using stolen, counterfeit or jerry-rigged tools.

Consequently, there is a need for more effective tamper-resistant terminations to counter the rising theft of cable services and sophistication of cable service thieves. Moreover, the device should preferably have a sealing member that is configured and dimensioned to provide a secure seal of any components within the connector body. Additionally, it should be possible for the device to be installed and removed easily by an authorized individual and resistant to attempts at removal by an unauthorized person.

### SUMMARY OF THE INVENTION

It is a primary object of the present invention to improve cable systems.

It is a further object of the present invention to prevent the theft of service of a cable system.

A still further object of the present invention is to provide a tamper-resistant termination for an unused port in which the means for removing the termination is not apparent from a visual inspection of the device.

The present invention is directed to a tamper-resistant device for terminating a connection. The device includes a housing with an inner wall defining an inner bore and at least one recess in the inner wall thereof. The device further includes a connector body sized and configured to fit within the inner bore and rotate independently of the housing. The connector body has interior threads at its first end for engaging the threads of an unused cable port. The connector body also has at least one recess in its outer surface that will align with the recess in the housing in a particular rotational position. A locking member sized and configured to fit within either the first recess in the connector body or the second recess in the inner wall of the housing. The locking member is selectively moveable between a first retracted position and a second extended position to rotationally engage and disengage the connector body with the housing. In the first retracted position, the locking member is contained substantially entirely within either the first recess in the housing or the second recess in the connector body. In the second extended position, the locking member is partially disposed within the first recess in the connector body and partially disposed within the second recess in the housing. When the locking member is in the first retracted position, the housing rotates independently of the connector body. However, when the recesses are aligned and the locking member is placed in the second extended position, the connector body rotates together with the housing allowing the internal threads on the first end of the connector body to engage and disengage the corresponding threads on a cable port.

The housing has a second end which may have an inner wall defining a third recess. The outer surface of the second end of the housing may have external threads for attaching the unused coaxial cable and connector. Cable services can be reinstated simply by removing the termination and reattaching the connector to the port.

The connector body may be retained within the housing through the use of a snap ring which is disposed between corresponding grooves in the outer surface of the connector body and the inner wall of the first end of the housing. Alternatively, the connector body may be retained by other well known means of snap engagement, such as a protruding ridge on the outer surface of the connector body which mates with a corresponding groove on the inner surface of the housing.

The device may also include a sealing member, such as an O-ring or washer, disposed between the housing and the connector body. The sealing member may be retained in position by a groove in the connector body, the housing, or both. The sealing member will tend to prevent the migration of water, dirt and other contaminants that could cause corrosion or otherwise impede the independent rotation of the housing and the connector body while the locking member is in the first retracted position. The device may also include a resistor case mounted within the connector body for housing a resistor to match the impedance of the coaxial cable.

The present invention is also directed to a tool for engaging the housing and selectively moving the locking member between the first retracted position and second extended position. The tool may engage the housing in several different ways. In the first embodiment, the tool has a protruding pin or key on its face, that engages a correspondingly shaped recess or keyway on the second end of the housing. When the key mates with the keyway, rotation of the tool causes rotation of the housing. The keyway may be offset from or coaxial with the longitudinal axis of the housing.

The tool also provides a means for selectively moving the locking member between the first retracted and second extended positions. The means for moving the locking member includes a locking member which is composed of ferrous metal or magnetized material and a tool that includes a magnet. In the first embodiment, the member is formed of ferrous metal, such as iron or steel, and the center core of the tool includes a magnet. Alternatively, the member is formed of magnetized material wherein the magnetic pole at the distal end of the member is opposite to the pole at the leading end of the tool. In this embodiment, in the first retracted position, the locking member is disposed substantially entirely within a recess in the second end of the connector body. The recess is substantially parallel to and offset from the central axis of the body and housing, although other arrangements including coaxial and radial orientations are contemplated as within the scope of the invention. The magnetic force supplied by the magnet acting upon the locking member must be sufficient to attract the member and cause the member to move toward the second end of the housing. As the housing is rotated such that the first recess is aligned with the second recess, the magnetic force supplied by the tool will cause the end of the locking member to move partially into the recess in the inner surface of the housing and engage the housing such that further rotation of the housing causes the connector body to rotate and engage or disengage the corresponding threads of the connector body and the port in order to install and remove, respectively, the termination device to the port.

Alternatively, a locking member of magnetized material may be disposed in a first retracted position substantially entirely within the second recess in the housing. In this embodiment, the magnetic pole of the distal end of the locking member of the tool would be the same as the pole at the leading edge of the tool. Such an alignment would cause the locking member to move away from the leading edge of the tool into a second extended position. As the housing is rotated such that the first recess is aligned with the second recess, the magnetic forces supplied by the tool and the locking member cause the proximal end of the locking member to move partially into the recess in the second end of the connector body and engage the body such that further rotation of the housing causes the connector body to rotate and engage or disengage the corresponding threads of the connector body and the port.

In alternative embodiments, the third recess may be used as the keyway. For example, the recess could be hexagonally shaped to receive and engage a magnetized Allen or hexagonal wrench. Furthermore, the face of the tool could include a recess or keyway that mates with a protruding pin or key on the second end of the housing.

### BRIEF DESCRIPTION OF THE DRAWINGS

For a further understanding of these and objects of the invention, reference will be made to the following detailed description of the invention which is to be read in connection with the accompanying drawing, where:

FIG. 1 illustrates an exemplary four-port tap employing locking termination devices of the present invention.

FIG. 2 shows a partially cross-sectioned perspective view of a locking termination device of the present invention in an unlocked condition.

FIG. 3 shows a partially cross-sectioned perspective view of a cable termination device and complementary tool of the present invention.

FIG. 3A shows a cross-sectioned cable termination device and alternative embodiment of the complementary tool of the present invention.

FIG. 3B shows a cross-sectioned cable termination device and further alternative embodiment complementary tool of the present invention.

FIG. 4 shows a cross-sectioned cable termination device engaged with the complementary tool of the present invention in a locked condition.

FIG. 5 shows a partially cross-sectioned perspective view of an alternative embodiment of the cable termination device of the present invention in an unlocked condition.

FIG. 6 shows a partially cross-sectioned perspective view of the alternative embodiment of FIG. 5 in a locked condition.

FIG. 7 shows a partially cross-sectioned perspective view of a second alternative embodiment of the cable termination device of the present invention in an unlocked condition.

FIG. 8 shows a partially cross-sectioned perspective view of the alternative embodiment of FIG. 7 in a locked condition.

FIG. 9 shows an exploded perspective view of the alternative embodiment of FIG. 7.

FIG. 10 shows a reverse-angle exploded perspective view of the alternative embodiment of FIG. 9.

### DETAILED DESCRIPTION OF THE INVENTION

In the description which follows, any reference to either direction or orientation is intended primarily for purposes of illustration and is not intended in any way as a limitation on the scope of the present invention. Also, the particular embodiments described herein, although being preferred, are not to be considered as limiting of the present invention. Furthermore, like parts or elements in the various drawings hereto are identified by like numerals for ease of reference.

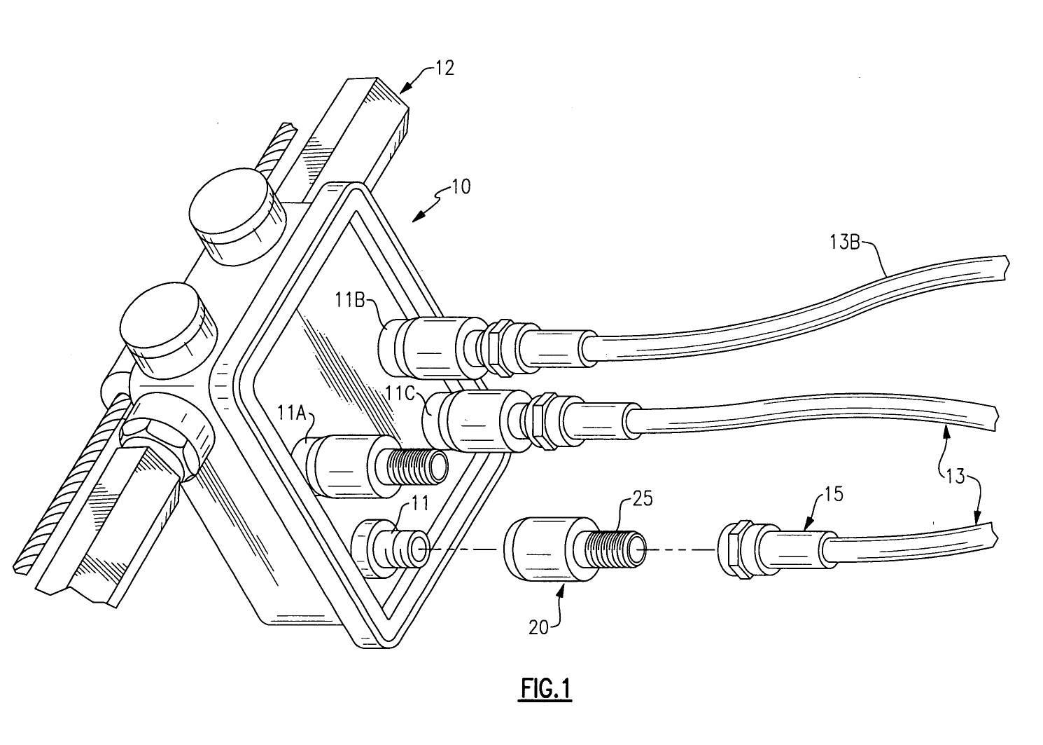

In FIG. 1, there is illustrated a conventional four-port tap 10 used in coaxial cable transmission systems. The tap 10 is placed along a trunk line 12 to distribute cable services through drop lines 13 to various subscribers in the geographic area of the tap. A cable connector 15 is installed on the end of each drop line 13, which mates with a threaded port 11 to provide cable services to the subscriber.

In instances where the number of ports exceeds the number of subscribers in a given geographical area, a termination device 20 may be installed on an unused port 11A to prevent an unauthorized connection and theft of cable services. In instances where a residence has been previously wired, but is no longer subscribing to services, rather than removing an entire drop line, a termination device may be interposed between the port 11B and the drop line to the non-subscribing residence 13B. External threads 25 may be added to the termination device to retain the unused drop line should the particular residence re-subscribe. Cable service may be reactivated simply by removing the locking termination device and reconnecting the connector of the drop line to the port.

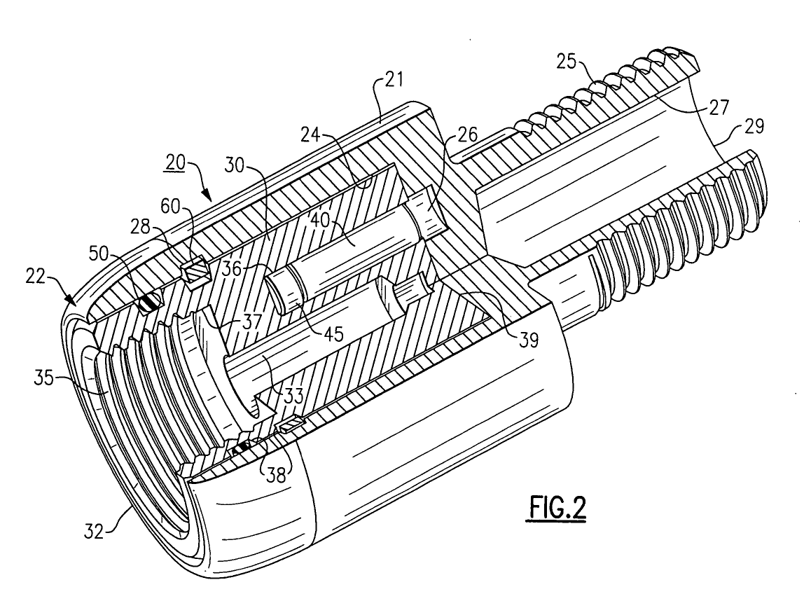

In FIG. 2, there is shown a first embodiment of a cable termination device 20 of the present invention. The termination device comprises a connector body 30 and a housing 21 that surrounds the connector body. The connector body has a first end 32 which has a first inner wall 37 defining an inner bore. The inner wall has female threads 35 to mate with the male threading of a terminal post 11. The inner bore may also include a resistor case 33 which may house a resistor (not shown) included as part of the termination device to match the impedance of the coaxial cable. The outer surface of the connector body may include one or more grooves 38 for the seating of either a sealing member 50, a snap-ring 60, or both. The sealing member of the first embodiment is an O-ring of suitable elastomeric material, however, other known sealing means such as washers, lubricants and the like are contemplated. The sealing member is intended to create an environmental seal to prevent the ingress of moisture, dirt and other contaminants between the connector body and the housing, which may, over time, cause corrosion or otherwise impede the ability of the connector body to rotate independently of the housing. The connector body also includes a first recess 36, which in the first embodiment extends in a generally axial direction from the second end 39 of the connector body.

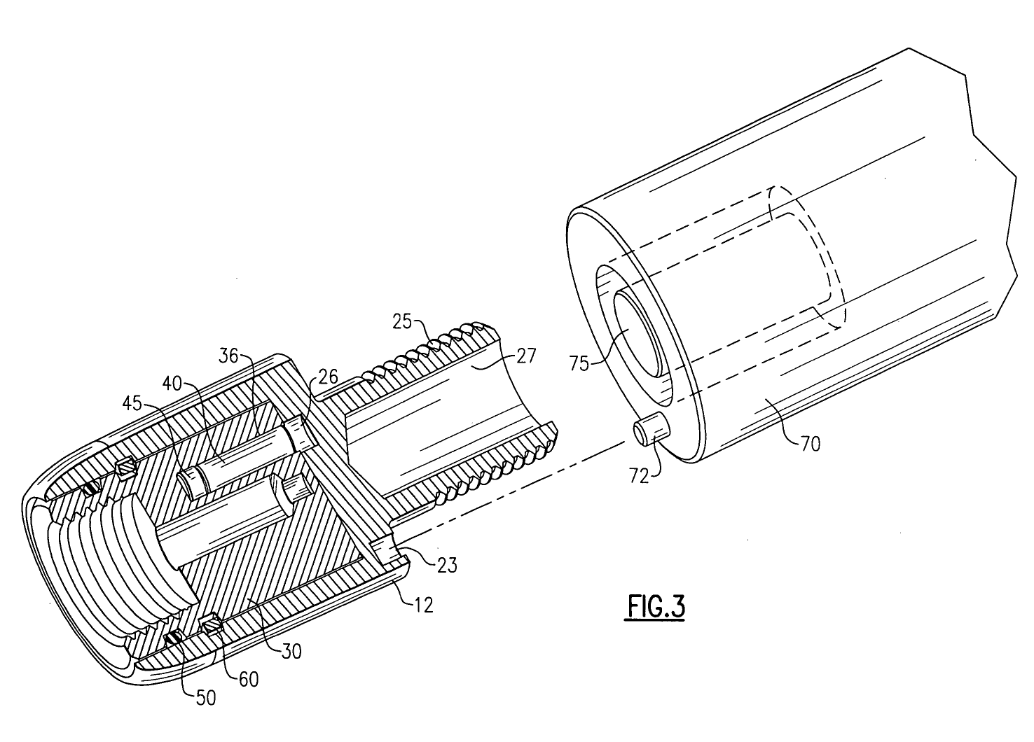

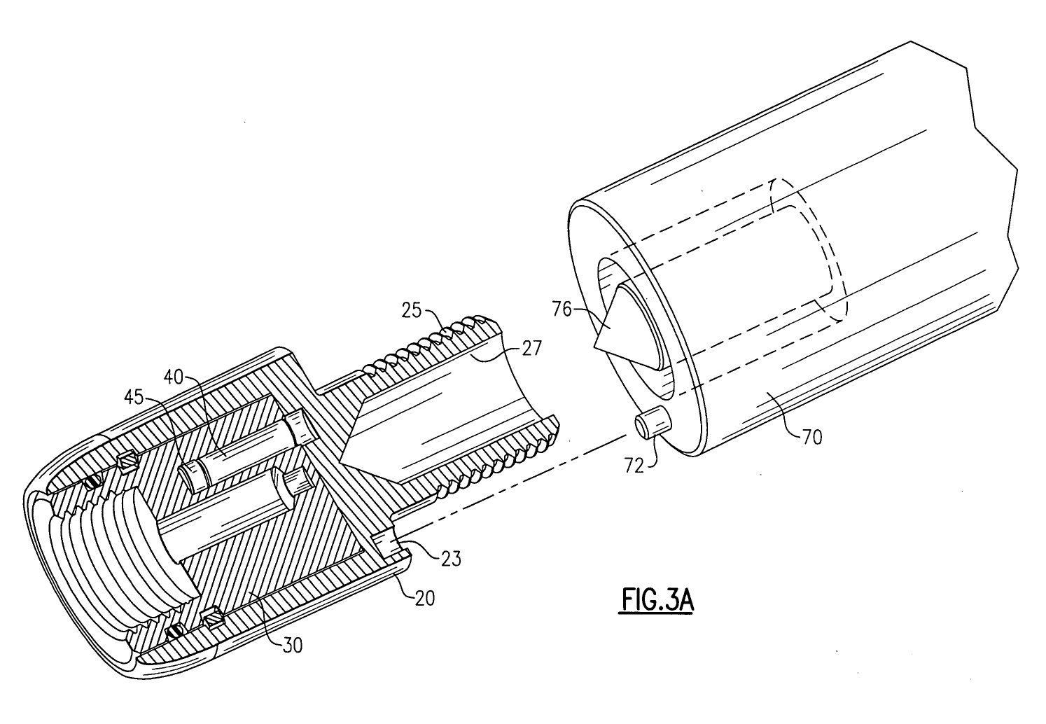

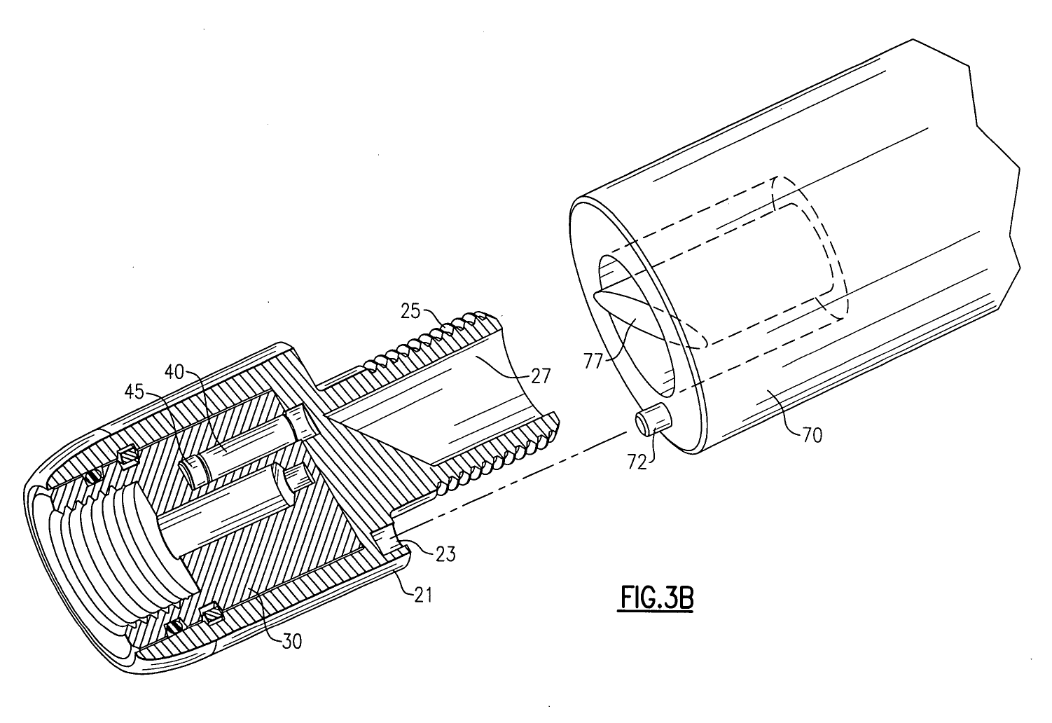

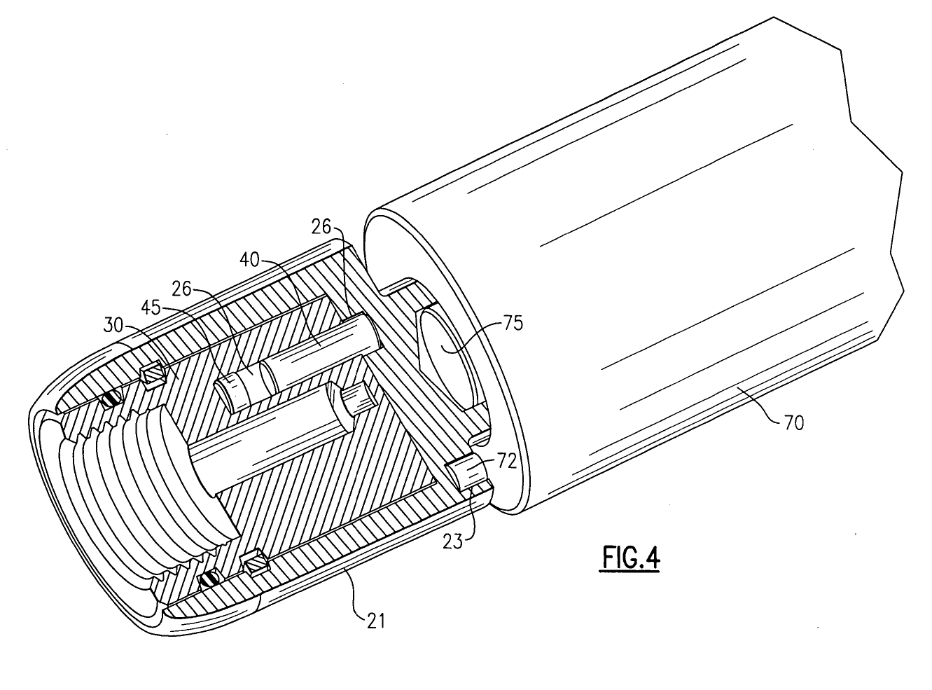

The housing 21 has a first end 22 which includes a first inner wall 24 defining a first inner bore. The inner wall 24 of the housing is sized and configured to house the connector body 30. The inner wall 24 may include one or more grooves 28 for the seating of a sealing member 50, a snap-ring 60, or both. The inner wall of the housing also includes a second recess 26 located and sized to align with the first recess 36 in the connector body in a particular rotational position. In the first embodiment, the second end 29 of the housing includes a second cylindrical inner wall 27 defining a third recess. The second end 29 of the housing 21 may also include external or male threads 25 for the mating of a coaxial cable connector of a drop line. The second end 29 of the connector body may also include a keyway 23, shown in FIGS. 3 and 4, for mating with a key 72 of the complementary tool capable of imparting rotational force upon the housing. In the first embodiment, the keyway is a cylindrical recess off-set from the central axis of the housing. Alternatively, the keyway may also be within or even coaxial with the third recess. For example, the third recess could be hexagonally shaped to receive a magnetic hexagonal or Allen wrench for applying rotational force to the housing. In still another embodiment, the keyway could be located on the face of the complementary tool with the protruding key located on or near the second end of the housing.

In FIGS. 2 and 3, a locking member 40 is shown in a first retracted position fully contained within the first recess 36 of the connector body and, as will be explained in greater detail below, will be selectively moved to a second extended position in which the locking member is disposed at least partially within the first recess of the connector body and the second recess of the housing. When the locking member is in the first retracted position, the housing rotates independently of the connector body whereby rotational movement of the housing does not rotate the connector body or engage or disengage the corresponding threads of the connector body and the port. In the embodiment of FIG. 2, the first recess 36, the second recess 26 and the locking member 40 are substantially cylindrical in shape, although other variations in shape, such as a square or hexagonal prism are contemplated. In the first embodiment, the locking member 40 is entirely within the first recess 36 in the connector body in the first retracted position shown in FIG. 2.

There may also be disposed in the proximal end of the first recess 36 a biasing member 45 that tends to retain the locking member 40 in the first retracted position until an external force selectively moves the locking member into the second extended position. In the first embodiment, the biasing member 45 is a small magnet that is press fit or otherwise adhered to the inner wall of the first recess in the connector body 30. This magnet imparts sufficient magnetic attractive force upon the locking member to retain the locking member in the first retracted position in opposition to gravitational or other forces otherwise acting upon the locking member. Alternatively, the biasing member 45 may be a spring or the like tending to keep the locking member retracted within the first recess.

FIG. 3 illustrates an embodiment of the complementary tool 70 of the present invention used to selectively move the locking member 40 between the first retracted and second extended positions. The tool 70 includes a strong magnet 75 dimensioned to fit within the third recess of the second end 29 of the housing 21. The tool may also include a key 72 protruding from the end of the tool. Alternatively, the tool may include a keyway that mates with a key on or near the second end of the housing. In the exemplary embodiment of the tool the key comprises cylindrical protrusion on the face of the tool off-set from the central axis of the tool an amount substantially equal to the off-set of the keyway 23 in the second end 29 of the housing.

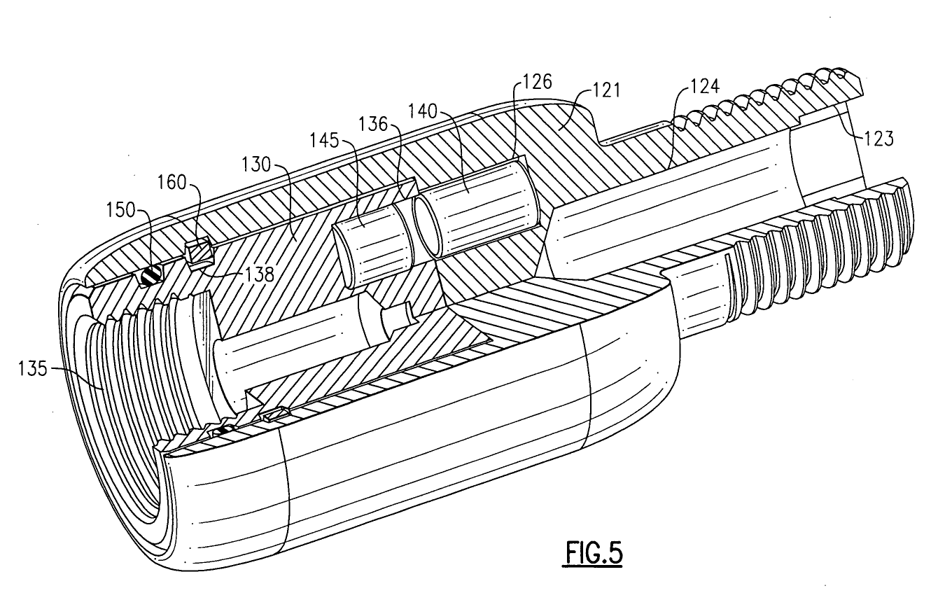

Upon the insertion of the magnet 75 of the tool into the third recess, as depicted in FIG. 4, the attractive magnetic force of the tool acts upon the ferrous material of the locking member 40 to overcome the force of the biasing member 45 and, when the recesses are aligned, will move the locking member 40 from the first retracted position into the second extended position. When the locking member is positioned in the second extended position, the locking member is partially disposed within said first recess 36 and partially disposed in said second recess 26 whereby rotation of the housing 21 causes rotation of the connector body 30. In the second extended position, rotation of the housing rotates the connector body thereby engaging or disengaging the mating threads of the connector body 35 and the port 11. When the magnet 75 of the tool 70 is removed from the third recess, the force exerted by the biasing member 45 upon the locking member 40 returns the locking member to the first retracted position. In the first embodiment of the present invention, the termination device relies upon the attractive force of the magnet 75 of the tool, however, as will be illustrated in the further embodiments described below, repulsive magnetic forces may also be used when the locking member is fully disposed within the second recess 26 in the housing 30 in a first retracted position as shown in FIG. 5.

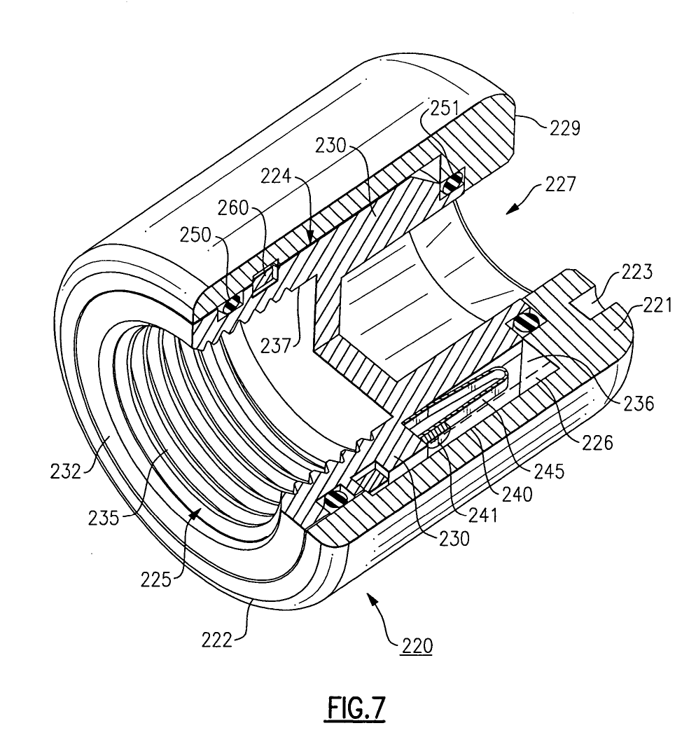

FIG. 3A depicts an alternative embodiment of the tool 70 and third recess. In FIG. 3A, the tip of the magnet 76 is pointed and which fits further into the complementary third recess of the connector body. The shape of the magnet can be manipulated to affect the magnetic field applying magnetic force to the locking member 40. For example, in FIG. 3B, the shape of the magnet 77 may be asymmetrical and configured to exert greater magnetic force in the location of the locking member 40 and cooperating first and second recesses 36 and 26, respectively. While the variations in the shape of the magnet are shown with respect to the first embodiment of FIGS. 2 and 3, such variations are equally applicable to the alternative embodiments of FIGS. 5 and 7.

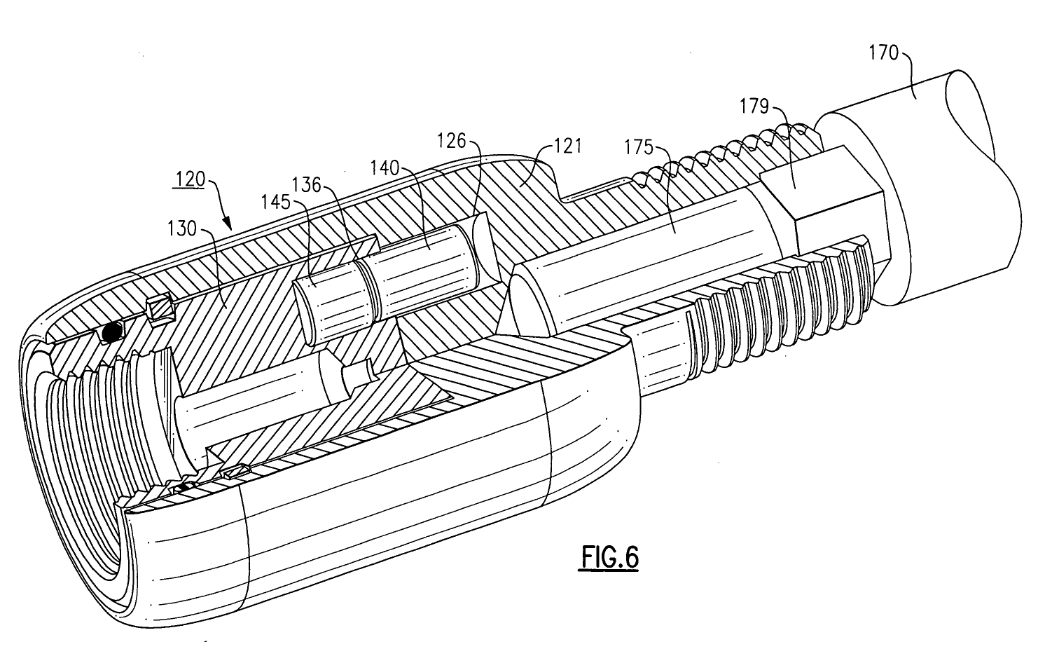

In FIGS. 5 and 6, an alternative embodiment of the termination device 120 of the present invention is shown. The alternative embodiment similarly includes a housing 121 and connector body 130. The first end 132 of the connector body has an inner wall 137 defining an inner bore. The inner wall has threads to mate with the corresponding threads of a port 11. The outer surface of the connector body may have one or more grooves 138 for the seating of a sealing member 150, a snap-ring 160, or both. The second end 139 of the connector body includes a first recess 136, into which is disposed a biasing member 145. Alternatively, the biasing member may be a spring located in the inner portion of second recess 126 which tends to retain the locking member 140 in the first retracted position.

The housing 121 of the alternative embodiment has a first end 122 having an inner wall 137 defining an inner bore. The inner wall is sized and configured to house the connector body 130 and may have one or more grooves for the seating of the sealing member 150, a snap-ring 160 or both. The inner wall has a second recess 136 into which is at least partially disposed the locking member 140. The second end 129 of the housing has an inner wall 127 defining a third recess. In this alternative embodiment, the inner portion 124 of the third recess of substantially cylindrical shape for receiving a complementary shaped magnet 175. The outer portion of the third recess 123 is substantially hexagon-shaped for receiving a hexagonal-shaped shank 179 of the magnet of the tool 170. The hexagonal-shaped shank 179 and outer portion of the third recess 182 act as the key and keyway for exerting rotational force upon the housing 130.

In the alternative embodiment, the locking member 140 and the biasing member are magnetized materials with like poles facing each other. The repulsive magnetic force between the like poles tends to retain the locking member 140 fully within the second recess 126 in the connector body in a first retracted position such that the housing and the connector body rotate independently. When a tool 170 is inserted into the third recess, the stronger repulsive magnetic force applied by the magnet 175 of the tool causes the locking member 140 to move into a second extended position, as shown in FIG. 6, where the locking member is partially disposed within the first recess 126 of the connector body and partially disposed within the second recess 136 of the housing. When the locking member 140 is in the second extended position, rotation of the housing 121 causes rotation of the connector body 130 thereby engaging and disengaging the complementary threads of the connector body 135 and the port 11. When the tool is removed from the third recess, the repulsive magnetic force between the biasing member 145 and the locking member 140 causes the return of the locking member to the first retracted position.

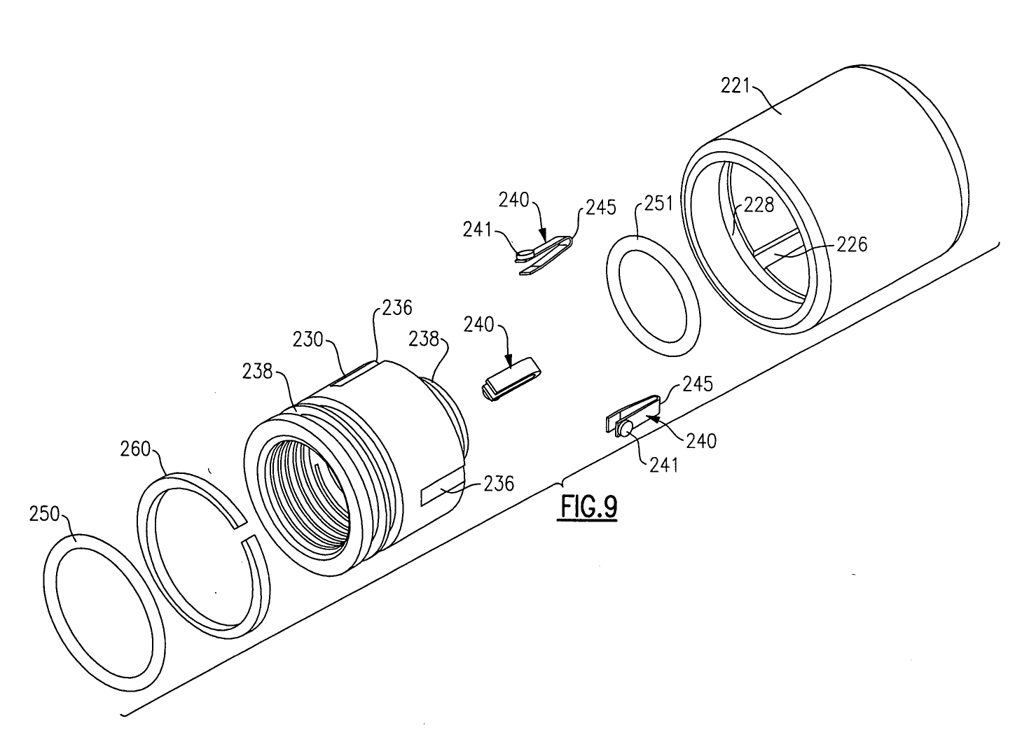

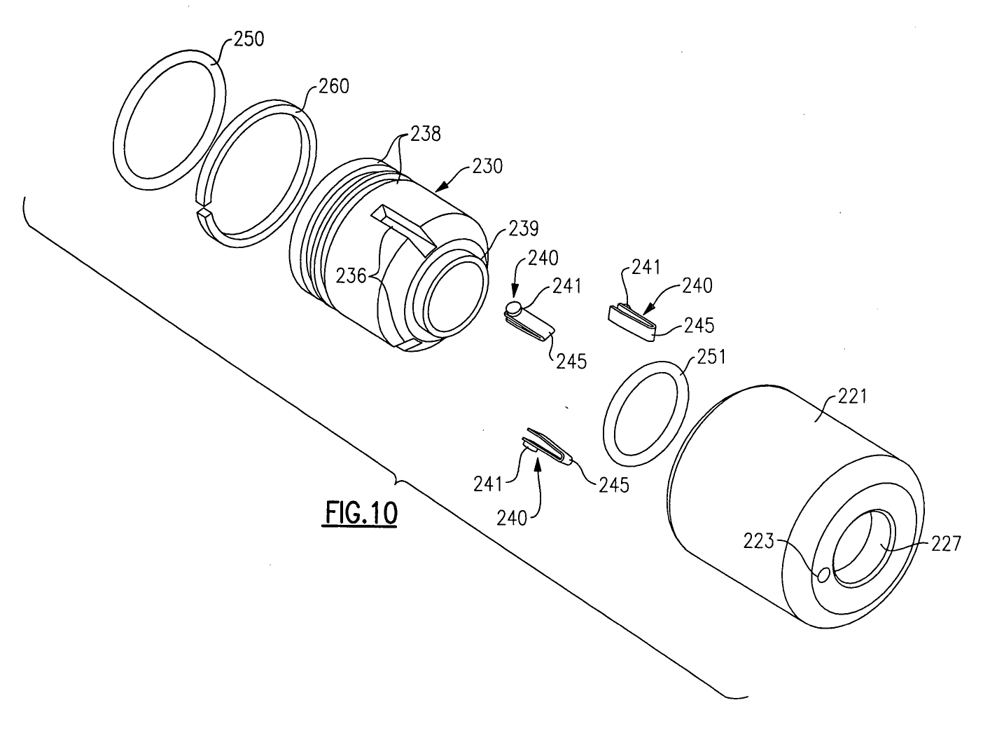

A second alternative embodiment of a termination device 220 of the present invention is depicted in FIGS. 7-10. The termination device 220 is similarly comprised of a connector body 230 and housing 221. The connector body 230 has a first end 232 which has a first inner wall 237 defining an inner bore. The inner wall has threads 235 to mate with the threading of a terminal post 11. The outer surface of the connector body may include one or more grooves 238 for the seating of first and second sealing members 250 and 251, a snap-ring 260, or any combination of the three. The second end 239 of the connector body has an inner wall 227 that defines a central, generally coaxial recess for receiving a magnetized, complementary tool. In the second alternative embodiment, the outer surface of the connector body also includes at least one lateral recess 236, which in the second alternative embodiment takes the form of a longitudinal channel extending partially along the outer surface of the connector body.

The housing 221 has an inner wall 224 defining a cavity with a first opening 225 at the first end 222 and a second opening 227 at the second end 229. The inner wall 224 of the housing is sized and configured to house the connector body 230. The inner wall 224 may include one or more grooves 228 for the seating of first and second sealing members 250 and 251, a snap-ring 260, or any combination of the three. As the cavity has two openings, it is preferable to use two sealing members to prevent the ingress of moisture from either direction or opening. The inner wall of the housing also includes at least one recess 226 located and sized to align with the lateral recess or recesses 236 in the connector body in a particular rotational position. While the complementary recesses shown in FIGS. 7-10 are longitudinal slots extending partially along the inner wall of the housing, other configurations such as circular or tapered detents are contemplated. In the second alternative embodiment, the second opening 227 of the housing is sized for insertion of the complementary tool. The second end 229 of the connector body may also include a keyway 223, for mating with a key 272 of the complementary tool capable of imparting rotational force upon the housing. The particular keyway depicted in this embodiment is a cylindrical recess off-set from the second opening of the housing. Alternatively, the keyway could be located on the face of the complementary tool with the protruding key located on or near the second end of the housing. In still another embodiment, the second opening may be hexagonal-shaped for the engagement of a complementary hexagonal shaped shank on the tool for exerting a rotational force upon the housing.

At least one locking member 240 is at least partially disposed within a lateral recess 236 of the connector body or the complementary recess 226 of the housing. The locking member 240 is selectively positioned between a first retracted position in which the locking member is substantially fully disposed within either the lateral recess 236 or the recess in the inner surface of the connector body 226, and a second extended position in which the locking member is disposed at least partially within the lateral recess of the connector body and the complementary recess of the housing. When the locking member is disposed in the first retracted position, the housing rotates independently of the connector body whereby rotational movement of the housing does not rotate the connector body or engage or disengage the corresponding threads of the connector body and the port. In the second alternative embodiment of FIGS. 7-10, three locking members in the form of leaf springs 245 with attached magnets 241 are depicted, although coiled springs rather than leaf springs may also be used. The springs bias the locking member to remain in a first retracted position wherein the springs 245 and attached magnets 241 are retained fully within the lateral recesses 236 in the connector body, as depicted in FIG. 7, such that the housing rotates independently of the connector body.

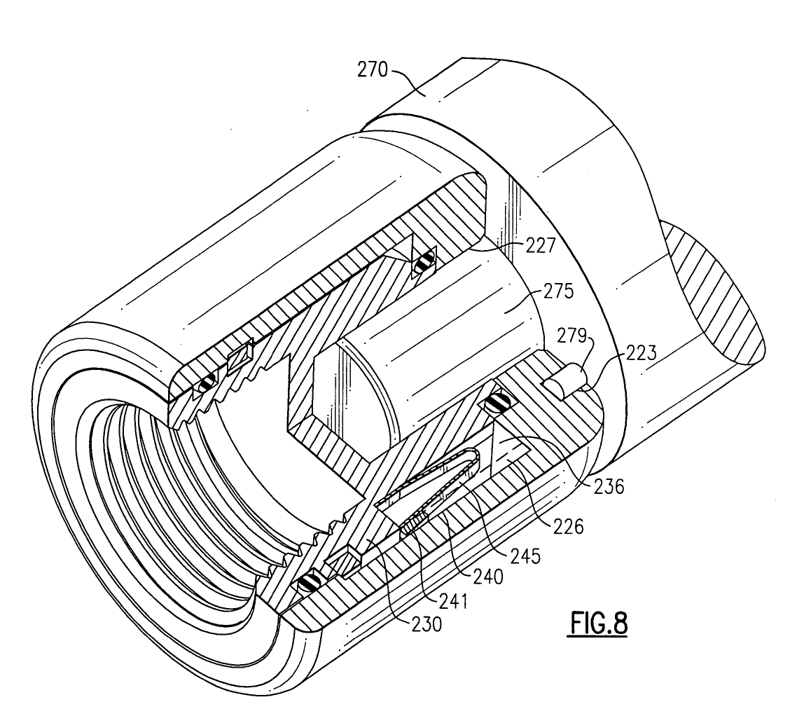

FIG. 8 illustrates the second alternative embodiment of the termination device 220 engaged with the complementary tool 270 used to selectively move at least part of the locking members 240 between the first retracted and second extended positions. The tool 270 includes a strong magnet 275 configured to fit through the second opening 227 of the housing and within the coaxial recess of the second end 239 of the housing 221. The tool may also include a key 272 protruding from the end of the tool which mates with the keyway 223 on the second end of the housing. Alternatively, the tool may include a keyway that mates with a protruding key on or near the second end of the housing. In FIGS. 7, 8 and 10, the key comprises cylindrical protrusion on the face of the tool off-set from the central axis of the tool an amount substantially equal to the off-set of the keyway 223 in the second end 229 of the housing.

Upon the insertion of the magnet 275 of the tool into the coaxial recess, as depicted in FIG. 8, the repulsive magnetic force of the tool acts upon the magnets 240 attached to the locking members to overcome the biasing force of the leaf springs 245 and move the locking member from the first retracted position into the second extended position. When the locking member is disposed in the second extended position, the locking member is partially disposed within said lateral recesses 236 of the connector body and partially disposed in said complementary recesses 226 in the housing whereby rotation of the housing 221 causes rotation of the connector body 230. In the second extended position, rotation of the housing rotates the connector body thereby engaging or disengaging the corresponding threads of the connector body 235 and the port 11. When the magnet 275 of the tool 270 is removed from the coaxial recess, the force exerted by the springs 245 returns the locking members 240 to the first retracted position.

While the present invention has been particularly shown and described with reference to the preferred mode as illustrated in the drawing, it will be understood by one skilled in the art that various changes in detail may be effected therein without departing from the spirit and scope of the invention as defined by the claims.

We claim:

1. A tamper-resistant device for terminating a coaxial cable to a threaded port comprising:
a housing having a first end and a second end, the first end of said housing including an inner wall bounding a first central bore, said inner wall having a first recess;
a connector body having a first end and a second end, the connector body being dimensioned to fit within the first central bore of the housing, the first end of the connector body having internal threads for connection to the threaded port, and the second end portion having a second recess,
a locking member located within one of said recesses movable between a first position in said one recess to a second position wherein the locking member is partially disposed within said first recess and partially disposed within said second recess.

2. The device of claim 1 including a sealing member disposed between the housing and the connector body.

3. The device of claim 2 wherein the connector body includes a groove for seating the sealing member.

4. The device of claim 1 including a means for snap-engaging the connector body within the housing.

5. The device of claim 3 wherein the means for snap-engaging is a snap-ring.

6. The device of claim 1 wherein the second end of the housing includes external threads for mating with a cable connector.

7. The device of claim 1 wherein the connector body includes a resistor chamber.

8. The device of claim 1 including a biasing member disposed in one of the first and second recesses tending to retain the locking member in said first position.

9. The device of claim 8 wherein the biasing member is a magnet.

10. The device of claim 8 wherein the biasing member is a spring.

11. The device of claim 9 wherein the locking member is composed of ferrous material.

12. The device of claim 9 wherein the locking member comprises a magnet.

13. The device of claim 9 wherein the biasing member uses attractive magnetic force to retain the locking member in said first position.

14. The device of claim 9 wherein the biasing member uses repulsive magnetic force to retain the locking member in said first position.

15. The device of claim 1 wherein the locking member is disposed within the first recess in the connector body in said first position.

16. The device of claim 1 wherein the locking member is disposed within the second recess in the housing in said first position.

17. The device of claim 1 which includes a recess at the second end of the housing for insertion of a complementary tool comprising a magnet.

18. The device of claim 17 wherein at least a portion of the recess at the second end of the housing has a polygonal cross-section.

19. The device of claim 1 wherein the housing includes a keyway engageable with a key of a complementary tool for applying rotational force to the housing.

20. The device of claim 1 wherein the housing includes a key engageable with a keyway of a complementary tool for applying rotational force to the housing.

21. The device of claim 18 wherein the housing includes a keyway engageable with a key of a complementary tool for applying rotational force to the housing.

22. The device of claim 19 wherein the housing has a longitudinal axis and the keyway is offset from said longitudinal axis of the housing.

23. The device of claim 20 wherein the housing has a longitudinal axis and the key is offset from the longitudinal axis of the housing.

24. The device of claim 21 wherein the keyway is coaxial with the longitudinal axis of the housing

25. The device of claim 21 wherein the keyway is the polygonal portion of the recess at the second end of the housing.

26. The device of claim 1 wherein the first recess is a bore in the second end of the connector body.

27. The device of claim 26 wherein the locking member is a cylindrical pin configured to fit within the first recess.

28. The device of claim 1 wherein the first recess is a longitudinal channel on the exterior surface of the connector body.

29. The device of claim 28 wherein the locking member comprises a spring with an attached magnet.

30. The device of claim 29 wherein the spring is a leaf spring.

31. The device of claim 28 wherein the body has at least two longitudinal recesses in the exterior surface of the body.

32. The device of claim 31 including at least two locking members.

33. The device of claim 1 wherein the housing has an opening at the second end thereof.

34. The device of claim 33 wherein the connector body includes a recess at the second end thereof for receiving at least a portion of a complementary tool.

35. The device of claim 33 wherein a second sealing member is disposed between the housing and the connector body.

36. The device of claim 33 wherein the housing includes a keyway engageable with a key of a complementary tool for applying rotational force to the housing.

37. The device of claim 33 wherein the housing includes a key engageable with a keyway of a complementary tool for applying rotational force to the housing.

38. The device of claim 36 wherein the keyway is at least a portion of the opening in the second end of the housing.

39. A tool for engaging a cable termination device having housing with a recess at one end of the device and a locking member selectively moved by the application of magnetic force between a first position and a second position, the tool comprising a magnet sized and configured for insertion into said recess.

40. The tool of claim 39 wherein the tool includes a key for cooperation with a keyway in said housing for applying rotational force to said housing.

41. The tool of claim 40 wherein the key is a protruding pin.

42. The tool of claim 41 wherein the protruding pin is substantially cylindrical.

43. The tool of claim 39 wherein the tool includes a keyway for cooperation with a key in said housing for applying rotational force to said housing.

44. The tool of claim 40 wherein the keyway is a substantially cylindrical recess.

45. The tool of claim 39 wherein the magnet has a polygonal cross-section.

46. The tool of claim 45 wherein the polygonal cross-section is hexagonal.

47. The tool of claim 39 wherein the tool includes a polygonal shank coaxial with said magnet.

48. The tool of claim 47 wherein the polygonal shank is at least a portion of the magnet.

49. The tool of claim 39 wherein the leading edge of the magnet tapered,

50. The tool of claim 49 wherein the taper of the leading edge of the magnet is asymmetrical about the longitudinal axis of the magnet.

51. A method for selectively engaging and disengaging a coaxial cable termination device comprising the steps of:
providing a housing having a first end and a second end, the first end of said housing including an inner wall bounding a first central bore, said inner wall having a first recess;
providing a connector body having a first end and a second end, the connector body being dimensioned to fit within the first central bore of the housing, the first end of the connector body having internal threads for connection to a threaded port, and the second end portion having a second recess;
providing a locking member located within one of said first recess and said second recess disposed for movement by application of magnetic force from a first position in said recess to a second position wherein the locking member is partially disposed within said first recess and partially disposed within said second recess;
providing a tool for engagement with the second end of the housing said tool comprising a magnet; and
engaging the tool with the second end of the housing to apply a magnetic force to move the locking member from said first position to said second position whereby rotation of the tool selectively engages and disengages the internal threads with the threaded port.

52. The method of claim 51 comprising the additional step of providing a termination device with a biasing member located within one of said first and second recesses tending to retain the locking member in said first position.

53. The method of claim 52 wherein said biasing member is a magnet and the magnetic force applied by the tool is sufficient to overcome the magnetic force of the biasing member and move the locking member from said first position to said second position.

54. The method of claim 53 wherein upon removal of said tool, the magnetic force applied by the biasing member returns the locking member to said first position.

55. The method of claim 51 wherein the magnetic force applied by the tool to the locking member is attractive magnetic force.

56. The method of claim 51 wherein the magnetic force applied by the tool to the locking member is repulsive magnetic force.
